(19) United States
(12) Patent Application Publication
(10) Pub. No.: US 2026/0070836 A1
(43) Pub. Date: Mar. 12, 2026

(54) FLUOROPHOSPHATE GLASS, NEAR-INFRARED CUT FILTER, AND OPTICAL DEVICE

(71) Applicant: AGC Inc., Tokyo (JP)

(72) Inventors: Kanako OHGUCHI, Shizuoka (JP); Takahiro SAKAGAMI, Shizuoka (JP); Masari WATANABE, Tokyo (JP)

(73) Assignee: AGC Inc., Tokyo (JP)

(21) Appl. No.: 19/395,517

(22) Filed: Nov. 20, 2025

Related U.S. Application Data
(63) Continuation of application No. PCT/JP2024/023839, filed on Jul. 1, 2024.

(30) Foreign Application Priority Data
Jul. 4, 2023 (JP) 2023-109751

(51) Int. Cl. C03C 3/247; C03C 3/062; C03C 4/08; G02B 5/20

(52) U.S. Cl. CPC C03C 3/247; C03C 3/062; C03C 4/082; G02B 5/208

(57) ABSTRACT

A fluorophosphate glass essentially contains each component of P, Al, K, Cu, F, and R, where R is one or more selected from Li, Na, Rb, and Cs. A content of Al³⁺ is 2% to 20% in terms of mass %, and an expected value of an ionic radius of an alkali metal component composed of K and R is 80 pm to less than 133 pm.

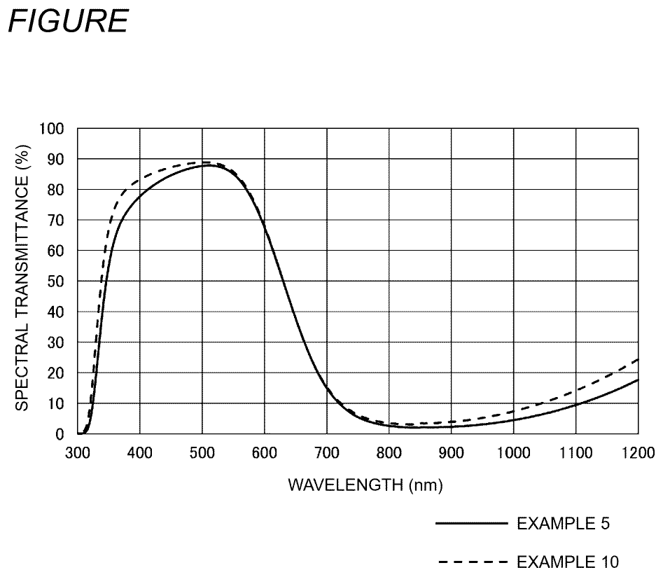

### TECHNICAL FIELD

The present invention relates to a fluorophosphate glass used for a color correction filter of a digital still camera, a color video camera, or the like, having excellent transmittance of light in a visible region and absorbing properties of light in a near-infrared region, and having good weather resistance, and a near-infrared cut filter and an optical device that include the glass.

### BACKGROUND ART

A solid state image sensor such as a CCD or CMOS used in a PC, a digital still camera, or the like has a spectral sensitivity ranging from a visible region to a near-infrared region around 1,200 nm. Therefore, since a solid state image sensor cannot provide good color reproducibility as it is, a near-infrared cut filter glass to which a specific substance that absorbs an infrared ray is added is used to correct the visual sensitivity.

In the near-infrared cut filter glass, two types of characteristics including optical characteristics and weather resistance are important.

As the optical characteristics of the near-infrared cut filter glass, a strong absorption ability in the near-infrared region (800 nm to 1,200 nm) and a high transmittance in the visible region to a red region (400 nm to 600 nm) are required, and in particular, a sharper absorption form (hereinafter, also referred to as sharp cutting property) is required in a form of a transmittance curve from a red transmission region to a near-infrared shielding region.

In order to obtain the optical characteristics, an optical glass in which a Cu component is added to a phosphate glass containing no fluorine (hereinafter, also referred to as copper-phosphate glass) has been developed as the near-infrared cut filter glass. However, the copper-phosphate glass has a problem in weather resistance. Therefore, an optical glass in which a Cu component is added to a fluorophosphate glass (phosphate glass containing fluorine) (hereinafter, also referred to as copper-fluorophosphate glass, fluorophosphate glass containing Cu, or fluorophosphate glass) has been developed so as to obtain high weather resistance. Compositions of the glasses are disclosed in Patent Literatures 1 to 4.
Patent Literature 1: JP2016-60671A
Patent Literature 2: JP2004-83290A
Patent Literature 3: WO2022/009558
Patent Literature 4: CN-A-114455836

### SUMMARY OF INVENTION

In the near-infrared cut filter glass disclosed in Patent Literature, it is difficult to achieve both optical characteristics and weather resistance at high levels.

That is, as described above, the copper-phosphate glass has high absorption ability in the near-infrared region and is excellent in sharp cutting property in the near-infrared region, but has a problem in weather resistance. On the other hand, the copper-fluorophosphate glass has high weather resistance, but has problems in absorption ability in the near-infrared region and sharp cutting property in the near-infrared region.

For example, as described in Patent Literature 4, in the case of the copper-fluorophosphate glass, an increase in a content of P in the glass is effective for enhancing the absorption ability in the near-infrared region and the sharp cutting property in the near-infrared region, but the weather resistance may be reduced.

An object of the present invention is to provide a fluorophosphate glass capable of achieving both high weather resistance and optical characteristics including high transmittance in a visible region to a red region, high absorption ability in a near-infrared region, and high sharp cutting property in the near-infrared region, and a near-infrared cut filter, an optical filter, and an optical device that include the glass.

As a result of intensive studies, the present inventors have found that, in a fluorophosphate glass containing Cu, a glass having good weather resistance and desired optical characteristics can be obtained by setting a content of an Al component and a content ratio of an alkali metal component to predetermined ranges, respectively.

That is, the present invention is as follows.

A fluorophosphate glass essentially containing each component of P, Al, K, Cu, F, and R, where R is one or more selected from Li, Na, Rb, and Cs, in which a content of Al³⁺ is 2% to 20% in terms of mass %, and an expected value of an ionic radius of an alkali metal component composed of K and R is 80 pm to less than 133 pm.

According to the present invention, it is possible to provide a fluorophosphate glass having both excellent optical characteristics and high weather resistance, and a near-infrared cut filter, an optical filter, and an optical device that include the glass.

### BRIEF DESCRIPTION OF DRAWINGS

The FIGURE is a graph illustrating transmittances of light in a wavelength of 300 nm to 1,200 nm in fluorophosphate glasses of Example 5 (inventive example) and Example 10 (comparative example).

### DESCRIPTION OF EMBODIMENTS

Hereinafter, embodiments of the present invention will be described in detail. The present invention is not intended to be interpreted as limited to the embodiments and mechanism of action to be described below.

In the present description, unless otherwise specified, a content of each component and a total content are expressed in terms of “mass %”. Here, the expression of mass % used in the present description indicates a percentage of a mass of each ion when a total mass of cation components is 100. In the present description, the expression of “α to β” indicating a range means “α or more and β or less”. The expression of “α to less than β” means “α or more and less than β”. In addition, a transmittance of a glass in the present embodiment is intended to include a reflection characteristic of a glass surface (that is, not an internal transmittance of the glass).

### <Fluorophosphate Glass>

The fluorophosphate glass of the embodiment of the present invention (hereinafter, also referred to as the fluorophosphate glass of the present embodiment, or simply referred to as the fluorophosphate glass or the glass) essentially contains each component of P, Al, K, Cu, F, and R (R is one or more selected from Li, Na, Rb, and Cs), in which a content of Al³⁺ is 2% to 20%, and an expected value of an ionic radius of an alkali metal component composed of K and R is 80 pm (picometers) to less than 133 pm (picometers).

The glass of the embodiment of the present invention is a copper-fluorophosphate glass containing P, Al, K, Cu, F, and R (R is one or more selected from Li, Na, Rb, and Cs) as essential components. A glass containing P as a main component has an effect of enhancing the absorption ability in a near-infrared region and the sharp cutting property in the near-infrared region. In addition, when the glass contains F and Al, the weather resistance can be improved. Further, by adjusting the expected value of the ionic radius of the alkali metal component composed of K and R to be 80 pm to less than 133 pm, the absorption ability and sharp cutting property in the near-infrared region can be improved, and by containing K and R, the weather resistance can be improved.

The alkali metal component is each component of K⁺, Li⁺, Na⁺, Rb⁺, and Cs⁺, and expected values of ionic radii of these components are defined as follows.

The ionic radius of each alkali metal component is as follows. An ionic radius r_{Li} of Li⁺ is 60 pm, an ionic radius r_{Na} of Na⁺ is 95 pm, an ionic radius r_{K} of K⁺ is 133 pm, an ionic radius r_{Rb} of Rb⁺ is 148 pm, and an ionic radius r_{Cs} of Cs⁺ is 169 pm. These ionic radii are values based on a document of The Nature of the Chemical Bond (“Theory of Chemical Combination”, translated by Masao Koizumi, 1963, KYORITSU SHUPPAN CO., LTD.) by L. Pauling (1931 to 1933). The expression of “cation %” is a unit in which a content of each cation component is expressed in terms of mol percentage when a total content of all cation components contained in the glass is 100 mol %.

The expected value of the ionic radius of the alkali metal component is calculated by the following formula.

$$Expected value of ionic radius = [ total of ionic radius of each component \times amount of cations of each component in alkali metal components ] \text{} / [ \text{} total of amount of cations of all alkali metal components ] ,$$

$$which is specifically described as follows .$$

$$[ total of ionic radius of each component \times amount of cations of each component in alkali metal components ] = ionic radius {r}_{Li} \times amount of cations of Li + ionic radius {r}_{Na} \times amount of cations of Na + ionic radius {r}_{K} \times amount of cations of K + ionic radius {r}_{Rb} \times amount of cations of Rb + ionic radius {r}_{Cs} \times amount of cations of Cs , and$$

$$[ total of amount of cations of all alkali metal components ] = amount of cations of Li + amount of cations of Na + amount of cations of K + amount of cations of Rb + amount of cations of Cs$$

In the glass of the embodiment of the present invention, when the expected value of the ionic radius of the alkali metal component (Li⁺, Na⁺, K⁺, Rb⁺, and Cs⁺) is set to 80 pm or more, it is possible to maintain a sharp absorption form in which absorption in the near-infrared region is enhanced while maintaining a high transmittance in a red region. The reason for this is presumed to be as follows.

A non-bridging oxygen is coordinated to Cu²⁺ in the glass to form a regular octahedron. When symmetry of the non-bridging oxygen coordinated to Cu²⁺ is high, there is a sharp absorption peak in the near-infrared region, but when the symmetry of the non-bridging oxygen is reduced for a reason to be described later, the absorption peak of Cu²⁺ shifts, and changes from a sharp absorption form to a broad absorption form in a form of a transmittance curve of the glass. It has been reported in, “‘Optical Properties of Glass II’, written by Kouhei Kadono (2009), NEW GLASS, Vol. 24, No. 2” that, in a transition metal including Cu, an absorption spectrum is likely to change depending on a change in a coordination environment in the glass.

The non-bridging oxygen coordinated to Cu²⁺ in the glass is attracted by a component having a large electronegativity existing in the periphery, and thus the symmetry is reduced. The electronegativity is a property representing a strength of a force of atomic nucleus in an atom attracting surrounding electrons. The ionic radius is a value indicating a distance from the atomic nucleus in the atom to an outermost electron shell. In a case of atoms belonging to the same group, the electronegativity is reduced as a distance between the atomic nucleus and a bonded electron pair increases, and thus a component having a large ionic radius can be referred to as a component having a small electronegativity.

Therefore, when a component having a large ionic radius among the alkali metal components is contained in the glass, the symmetry of the non-bridging oxygen coordinated to Cu²⁺ is not reduced, and a high absorption ability in the near-infrared region and a high sharp cutting property in the near-infrared region can be realized.

On the other hand, when the expected value of the ionic radius of the alkali metal component (Li⁺, Na⁺, K⁺, Rb⁺, and Cs⁺) is 133 pm or more, there is a concern that the weather resistance may be reduced. The reason for this is presumed to be as follows.

The weather resistance is evaluated based on a degree of deterioration of a glass surface caused when the glass is left to stand for a long time under high temperature and high humidity. Under high temperature and high humidity, H present on the glass surface penetrates into the glass, and attacks an —O—P—O— structure to cause hydrolysis. As a result, H₃PO₄ separated from the glass surface turns into a liquid state and remains, further reacts with the glass, causing a foreign matter to be precipitated, thereby deteriorating the glass surface. When an alkali metal component having a large ionic radius is contained in a large amount, the force to attract the non-bridging oxygen in the glass is weakened, and a strength of a glass structure is weakened, and therefore, when the glass is left to stand for a long time under high temperature and high humidity, H⁺ present on the glass surface is likely to penetrate into the glass, that is, the hydrolysis reaction is promoted, and the weather resistance of the glass is reduced.

Therefore, the expected value of the ionic radius of the alkali metal component is preferably 80 pm to less than 133 pm. When the expected value is 80 pm or more, an effect of high absorption ability and improved sharp cutting property in the near-infrared region is sufficiently obtained, and when the expected value is less than 133 pm, problems such as reduction in weather resistance are less likely to occur. Therefore, the expected value is more preferably 85 pm or more, further preferably 90 pm or more, still more preferably 95 pm or more, and most preferably 100 pm or more, and is more preferably 130 pm or less, further preferably 128 pm or less, still more preferably 125 pm or less, and most preferably 120 pm or less.

The glass of the embodiment of the present invention essentially contains the alkali metal component composed of K and R. When two or more types of alkali metal components are contained in the glass, the weather resistance can be improved. The reason for this is presumed to be as follows.

In a glass having low weather resistance, a glass surface deteriorates under high temperature and high humidity, and elution of precipitates and solutions is observed. The reason for this includes an ion exchange reaction between the alkali metal component and H⁺. When the glass is left to stand for a long time under high temperature and high humidity, an ion exchange reaction occurs between H⁺ present on the glass surface and alkali metal ions in a surface layer of the glass. Specifically, the alkali metal component is eluted to the glass surface by the ion exchange reaction, and H⁺ is likely to penetrate into the glass. An influence of H⁺ penetrating into the glass on the glass is as described above. Since the alkali metal component has a larger ion diffusion coefficient than other components, the ion mobility is high, the ion exchange reaction with H⁺ is likely to occur, and the weather resistance of the glass is reduced. It is known that when two or more types of alkali metal components are contained in

the glass in combination, the ion mobility of each alkali metal component is reduced due to a mixed alkali effect. Due to this effect, the ion exchange reaction between H′ present on the glass surface and the alkali metal component can be controlled, and the reduction in weather resistance can be prevented.

Each component that can form the glass of the present invention and a suitable content thereof is described below.

In the glass of the embodiment of the present invention, P (phosphorus) is contained as P⁵⁺. P⁵⁺ is a main component that forms the fluorophosphate glass, and is an essential component for improving the sharp cutting property in the near-infrared region. A content of P⁵⁺ is preferably 20% to 70%. When the content of P⁵⁺ is 20% or more, the effect thereof can be sufficiently obtained, and when the content of P⁵⁺ is 70% or less, problems such as instability of glass and reduction in weather resistance are less likely to occur. Therefore, the content of P⁵⁺ is more preferably 25% or more, further preferably 30% or more, and still more preferably 33% or more, and is more preferably 60% or less, further preferably 55% or less, still more preferably 50% or less, and most preferably 45% or less. As a raw material for P⁵⁺, from the viewpoint of preventing corrosion of a platinum crucible and preventing volatilization of the component, it is preferable to use phosphoric acid or phosphate.

In the glass of the embodiment of the present invention, F (fluorine) is contained as F⁻. F⁻ is an essential component for stabilizing the glass and improving the weather resistance. In the present description, when a total amount of all cation component elements contained in the glass is defined as 100 mass %, the content of F⁻ contained in the glass is indicated in terms of outer percentage. The content of F⁻ is preferably 3% to 60% in terms of outer percentage.

When the content of F⁻ is 3% or more in terms of outer percentage, an effect of the weather resistance is sufficiently obtained, and when the content of F⁻ is 60% or less in terms of outer percentage, problems such as a reduction in transmittance of light in a visible region, and absorption ability and sharp cutting property of light in the near-infrared region, a reduction in mechanical properties such as strength, hardness, and elastic modulus, and an increase in transmittance of ultraviolet rays are less likely to occur. The content of F⁻ is more preferably 4% or more in terms of outer percentage, further preferably 6% or more in terms of outer percentage, still more preferably 8% or more in terms of outer percentage, and most preferably 10% or more in terms of outer percentage, and is more preferably 50% or less in terms of outer percentage, further preferably 40% or less in terms of outer percentage, still more preferably 30% or less in terms of outer percentage, and most preferably 20% or less in terms of outer percentage.

In the glass of the embodiment of the present invention, Cu (copper) is contained as Cu⁺ or Cu²⁺, but in the description of the present application, the content is described assuming that all Cu exists as Cu²⁺:

Cu²⁺ is an essential component for improving the absorption ability in the near-infrared region. Since Cu²⁺ has a characteristic of forming a crosslinked structure by attracting phosphate chains in the glass, the glass structure is strengthened, and the weather resistance and the strength of the glass are improved. A content of Cu²⁺ is preferably 1% to 20%. When the content of Cu²⁺ is less than 1%, the absorption ability of the glass in the near-infrared region may be reduced. The content of Cu²+ is preferably 2% or more, more preferably 3% or more, further preferably 4% or more, and still more preferably 5% or more. When the content of Cu²⁺ is more than 20%, the glass becomes unstable, and a risk of devitrification is increased. The content of Cu²⁺ is preferably 18% or less, more preferably 16% or less, further preferably 15.2% or less, and still more preferably 14% or less.

A total amount of Cu is a total amount of Cu in terms of mass %, including those of monovalent, divalent, and other existing valences, and in a case where the content of all components in the glass of the present embodiment (excluding content of F⁻) is defined as 100%, a range of a content of the total amount of Cu in the glass is preferably 1% to 20%. When the total amount of Cu is 1% or more, an effect of the absorption ability in the near-infrared region can be sufficiently obtained, and when the total amount of Cu is 20% or less, a reduction in transmittance of the visible region can be prevented. A content of Cu⁺ expressed in terms of % can be determined such that (Cu⁺/total amount of Cu)×100[%] is in a range of 0.01% to 4.0%.

In the glass of the embodiment of the present invention, Al (aluminum) is contained as Al³⁺. Al³⁺ is a component forming the glass, and is an essential component for enhancing the strength of the glass, enhancing the weather resistance of the glass, and the like. When a content of Al³⁺ is 2% or more, an effect thereof is sufficiently obtained, and when the content of Al³⁺ is 20% or less, problems such as instability of glass and reduction in absorption ability and sharp cutting property in the near-infrared region are less likely to occur. The content of Al³⁺ is preferably 2% to 20%. The content of Al³⁺ is more preferably 3.5% or more, further preferably 4% or more, still more preferably 4.5% or more, and most preferably 5% or more, and is more preferably 19% or less, further preferably 18% or less, still more preferably 15% or less, and most preferably 13% or less.

As a raw material for Al³⁺, AlF₃, Al₂O₃, Al(OH)₃, and the like can be used. Among them, it is preferable to use AlF₃, since problems such as an increase in melting temperature, generation of unmelted matter, and instability of glass due to a reduction in charged amount of F⁻ are less likely to occur.

Li (lithium) is a component for lowering the melting temperature of the glass, lowering a liquid phase temperature of the glass, improving the weather resistance of the glass, stabilizing the glass, and the like. A content of Li⁺ is preferably 0% to 30%. When the content of Li⁺ is 30% or less, the glass is less likely to become unstable. Since the absorption ability and sharp cutting property in the near-infrared region are reduced when Li is contained, the content of Li⁺ is more preferably 28% or less, further preferably 25% or less, still more preferably 20% or less, and most preferably 10% or less. When the alkali metal component is only Li⁺, the weather resistance is improved, but the absorption ability and sharp cutting property in the near-infrared region are reduced, and therefore, it is necessary to further contain one or more alkali metal components having an ionic radius larger than that of Li⁺.

Na (sodium) is a component for lowering the melting temperature of the glass, lowering the liquid phase temperature of the glass, stabilizing the glass, and the like. A content of Na⁺ is preferably 0% to 40%. When the content of Na⁺ is 40% or less, the glass is less likely to become unstable. The content of Na is more preferably 30% or less, further preferably 25% or less, still more preferably 20% or less, and most preferably 10% or less. When the alkali metal component is only Na, one of effects of improving the weather resistance and improving the high absorption ability and sharp cutting property in the near-infrared region is obtained, and characteristics improved are different depending on a composition system. However, it is difficult to improve both characteristics at the same time. Therefore, it is necessary to contain one or more types of alkali metal components other than Na⁺ in order to improve the weather resistance, and to contain an alkali metal component having an ionic radius larger than that of Na⁺ in order to improve the absorption ability and sharp cutting property in the near-infrared region.

In the glass of the embodiment of the present invention, K (potassium) is contained as K⁺. K⁺ is an essential component having effects such as lowering the melting temperature of the glass, lowering the liquid phase temperature of the glass, and improving the absorption ability and sharp cutting property in the near-infrared region. A content of K⁺ is preferably 1% to 40%. When the content of K⁺ 40% or less, the glass is less likely to become unstable, which is preferable. The content of K⁺ is more preferably 2% or more, further preferably 5% or more, still more preferably 8% or more, and most preferably 10% or more, and since the weather resistance is reduced when K⁺ is contained, the content of K⁺ is preferably 30% or less, further preferably 25% or less, still more preferably 20% or less, and most preferably 14% or less. When the alkali metal component is only K⁺, the absorption ability and sharp cutting property in the near-infrared region are improved, but the weather resistance is reduced. Therefore, in order to improve the weather resistance by an alkali mixing effect, it is necessary to contain one or more types of alkali metal components other than K⁺.

Rb (rubidium) is a component having effects such as lowering the melting temperature of the glass, lowering the liquid phase temperature of the glass, and improving the absorption ability and sharp cutting property in the near-infrared region. A content of Rb⁺ is preferably 0% to 20%. When the content of Rb⁺ is 20% or less, the glass is less likely to become unstable, which is preferable. Since the weather resistance is reduced when Rb⁺ is contained, the content of Rb⁺ is more preferably 15% or less, further preferably 10% or less, and still more preferably 5% or less. When the alkali metal component is only Rb⁺, the absorption ability and sharp cutting property in the near-infrared region are improved, but the weather resistance is reduced. Therefore, in order to improve the weather resistance by an alkali mixing effect, it is necessary to contain one or more types of alkali metal components other than Rb⁺.

Cs (cesium) is a component having effects such as lowering the melting temperature of the glass, lowering the liquid phase temperature of the glass, and improving the high absorption ability and sharp cutting property in the near-infrared region. A content of Cs⁺ is preferably 0% to 20%. When the content of Cs⁺ is 20% or less, the glass is less likely to become unstable, which is preferable. Since the weather resistance is reduced when Cs⁺ is contained, the content of Cs⁺ is more preferably 15% or less, further preferably 10% or less, and still more preferably 5% or less. When the alkali metal component is only Cs⁺, the absorption ability and sharp cutting property in the near-infrared region are improved, but the weather resistance is reduced. Therefore, in order to improve the weather resistance by an alkali mixing effect, it is necessary to contain one or more types of alkali metal components other than Cs⁺.

K⁺0 and R⁺ (R⁺ is one or more selected from Li⁺, Na⁺, Rb⁺, and Cs⁺) are essential components for lowering the melting temperature of the glass, lowering the liquid phase temperature of the glass, stabilizing the glass, and the like. When a total amount of R⁺ and K⁺, that is, a total amount of Li⁺, Na⁺, K⁺, Rb⁺, and Cs⁺ (ΣR⁺+K⁺) is 14% or more, an effect thereof is sufficiently obtained, and when the total amount of R⁺ and K⁺ is 42% or less, the glass is less likely to become unstable, which is preferable. Therefore, the content of ΣR⁺+K⁺ is preferably 14% to 42%. The content of ΣR⁺+K⁺ is more preferably 14.5% or more, further preferably 15% or more, still more preferably 17% or more, and most preferably 18% or more. The content of ΣR⁺+K⁺ is more preferably 35% or less, further preferably 30% or less, still more preferably 28% or less, and most preferably 25% or less.

Mg (magnesium) is a component for lowering the melting temperature of the glass, lowering the liquid phase temperature of the glass, stabilizing the glass, enhancing the strength of the glass, enhancing the weather resistance of the glass, and the like. A content of Mg²⁺ is preferably 0% to 20%. When the content of Mg²⁺ is 20% or less, problems such as instability of glass and reduction in near infrared ray cutting property are less likely to occur. The content of Mg²⁺ is more preferably 15% or less, further preferably 10% or less, and still more preferably 5% or less.

Ca (calcium) is a component for lowering the melting temperature of the glass, lowering the liquid phase temperature of the glass, stabilizing the glass, enhancing the glass strength, enhancing the weather resistance of the glass, and the like. A content of Ca²⁺ is preferably 0% to 20%. When the content of Ca²⁺ is 20% or less, problems such as instability of glass and reduction in near infrared ray cutting property are less likely to occur. The content of Ca²⁺ is more preferably 1% or more, further preferably 2% or more, and is more preferably 18% or less, further preferably 15% or less, still more preferably 10% or less, and most preferably 7% or less.

Sr (strontium) is a component for lowering the melting temperature of the glass, lowering the liquid phase temperature of the glass, stabilizing the glass, enhancing the strength of the glass, enhancing the weather resistance of the glass, and the like. A content of Sr²⁺ is preferably 0% to 30%. When the content of Sr²⁺ is 30% or less, problems such as instability of glass and reduction in near infrared ray cutting property are less likely to occur. The content of Sr²⁺ is more preferably 1% or more, further preferably 2% or more, still more preferably 4% or more, and most preferably 5% or more, and is more preferably 25% or less, further preferably 20% or less, still more preferably 16% or less, and most preferably 14% or less.

Ba (barium) is a component for lowering the melting temperature of the glass, lowering the liquid phase temperature of the glass, stabilizing the glass, enhancing the absorption ability of light in the near-infrared region, enhancing the sharp cutting property in the near-infrared region, and the like. A content of Ba²⁺ is preferably 0% to 40%. When the content of Ba²⁺ is 40% or less, problems such as instability of glass are less likely to occur. The content of Ba²⁺ is more preferably 1% or more, further preferably 5% or more, still more preferably 10% or more, and most preferably 13% or more, and is more preferably 35% or less, further preferably 30% or less, still more preferably 22% or less, and most preferably 19% or less.

R″²⁺ (R″²⁺ is one or more components selected from Mg²⁺, Ca²⁺, Sr²⁺, and Ba²⁺) is a component for lowering the melting temperature of the glass, lowering the liquid phase temperature of the glass, stabilizing the glass, and the like. When a total amount of R″²⁺, that is, a total amount (ΣR″²⁺) of Mg²⁺, Ca²⁺, Sr²⁺, and Ba²⁺, is 14.5% or more, the effect thereof is sufficiently obtained, and when the total amount of R″²⁺; is 35% or less, the glass is less likely to become unstable. Therefore, the content of ER″²⁺ is preferably 14.5% to 35%. The content of ΣR″²⁺ is more preferably 16.5% or more, further preferably 18% or more, still more preferably 20% or more, and most preferably 22% or more, and is more preferably 34% or less, further preferably 32.5% or less, still more preferably 30% or less, and most preferably 28% or less.

Zn (zinc) has effects such as lowering the melting temperature of the glass and lowering the liquid phase temperature of the glass. A content of Zn²⁺ is preferably 0% to 20%. When the content of Zn²⁺ is 20% or less, problems such as instability of glass, reduction in solubility of the glass, and reduction in near infrared ray cutting property are less likely to occur. The content of Zn (zinc) is more preferably 15% or less, further preferably 10% or less, and still more preferably 5% or less. Most preferably, Zn (zinc) is not contained.

(Content of P⁵⁺)/ΣR′ (R′ is one or more components selected from Al³⁺, Mg²⁺, and Li⁺, and ΣR′ is a total amount of R′) is preferably 3.0 to 7.7.

P⁵⁺ is a component for enhancing the sharp cutting property in the near-infrared region, but also has an effect of reducing the weather resistance. Al³⁺, Li⁺, and Mg⁺ are each a component having an effect of improving the weather resistance.

Therefore, when a ratio of the content of P⁵⁺ to ΣR′ is 7.7 or less, the weather resistance of the glass can be improved. When the ratio of the content of P⁵⁺ to ΣR′ is set to 3.0 or more, the sharp cutting property of the glass in the near-infrared region can be maintained high. The ratio of the content of P⁵⁺ to ΣR′ is more preferably 3.2 or more, further preferably 3.5 or more, still more preferably 4.0 or more, and most preferably 4.5 or more. The ratio of the content of P⁵⁺ to ΣR′ is more preferably 7.5 or less, further preferably 7.0 or less, still more preferably 6.3 or less, and most preferably 5.5 or less.

B (boron) may be contained in a range of 20% or less in order to stabilize the glass. When a content of B³⁺ is 20% or less, problems such as deterioration in the weather resistance of the glass and deterioration in the near infrared ray cutting property are less likely to occur. The content of B³⁺ is more preferably 15% or less, further preferably 10% or less, still more preferably 8% or less, and most preferably 5% or less.

In the glass of the embodiment of the present invention, SiO₂, GeO₂, ZrO₂, SnO₂, TiO₂, CeO₂, WO₃, Y₂O₃, La₂O₃, Gd₂O₃, Yb₂O₃, and Nb₂O₅ may be contained in a range of 10% or less in order to improve the weather resistance of the glass. When the content of these components is 10% or less, problems such as generation of devitrified foreign matters in the glass and deterioration in the near infrared ray cutting property are less likely to occur. The content of these components is preferably 4% or less, more preferably 3% or less, further preferably 2% or less, and still more preferably 1% or less.

Any of Fe₂O₃, Cr₂O₃, Bi₂O₃, NiO, V₂O₅, MnO₂, and CoO is a component that reduces the transmittance of light in the visible region by being present in the glass. Therefore, it is preferable that these components are substantially not contained in the glass. Here, the expression “substantially not contained in the glass” means that the component is not contained except for unavoidable impurities, and means that the component is not intentionally added. Specifically, it means that a content of each of these components in the glass is about 100 ppm by mass or less.

In the glass of the embodiment of the present invention, from the viewpoint of ensuring the strength of the glass, the Young's modulus is preferably 48 GPa or more, more preferably 50 GPa or more, further preferably 55 GPa or more, and still more preferably 60 GPa or more.

In the glass of the embodiment of the present invention, an average coefficient of thermal expansion in a range of 30° C. to 300° C. is preferably 60×10⁻⁷/° C. to 180×10⁻⁷/° C., more preferably 65×10⁻⁷/° C. to 165×10⁻⁷/° C., further preferably 70×10⁻⁷/° C. to 157×10⁻⁷/° C., still more preferably 70×10⁻⁷/° C. to 150×10⁻⁷/° C., and most preferably 70×10⁻⁷/° C. to 143×10⁻⁷/° C.

In a case where the glass of the embodiment of the present invention is used for a color correction filter (near-infrared cut filter glass) for a solid state image sensor, the glass may be directly bonded to a packaging material since the glass also functions as a cover glass for hermetically sealing the solid state image sensor. In this case, when a difference in coefficient of thermal expansion between the near-infrared cut filter glass and the packaging material is large, peeling or breakage may occur in a bonded portion, and an airtight state cannot be maintained.

Generally, as the packaging material, materials such as a glass, a crystallized glass, ceramics, and alumina are used in consideration of heat resistance, and it is preferable to reduce a difference in coefficient of thermal expansion between these packaging materials and the near-infrared cut filter glass. Accordingly, the glass of the present embodiment preferably has an average coefficient of thermal expansion in a temperature range of 30° C. to 300° C. within the above range.

In the glass of the embodiment of the present invention, a spectral transmittance at a wavelength of 1,200 nm is preferably 22% or less when conversion of a plate thickness is performed such that a wavelength at which the transmittance in the near-infrared region is 50% (hereinafter, referred to as IR half value) is 630 nm. In this way, a glass having a low transmittance of light in the near-infrared region is obtained. The above spectral transmittance is more preferably 21% or less, further preferably 20% or less, and still more preferably 19% or less. The above spectral transmittance can be measured by a method described in Examples.

In the glass of the embodiment of the present invention, a spectral transmittance at a wavelength of 600 nm is preferably 60% or more when conversion of a plate thickness is performed such that the IR half value is 630 nm. In this way, a glass having a high sharp cutting property in the near-infrared region is obtained. The above spectral transmittance is more preferably 62% or more, further preferably 64% or more, and still more preferably 66% or more. The above spectral transmittance can be measured by a method described in Examples.

In the glass of the embodiment of the present invention, a spectral transmittance at a wavelength of 800 nm is preferably 4.0% or less when conversion of a plate thickness is performed such that the IR half value is 630 nm. In this way, a glass having a low transmittance of light in the near-infrared region is obtained. The above spectral transmittance is more preferably 3.8% or less, further preferably 3.6% or less, and still more preferably 3.4% or less. The above spectral transmittance can be measured by a method described in Examples.

In the glass of the embodiment of the present invention, a spectral transmittance at a wavelength of 420 nm is preferably 75% or more when conversion of a plate thickness is performed such that the IR half value is 630 nm. In this way, a glass having a high transmittance of light in the visible region is obtained. The above spectral transmittance is more preferably 78% or more, further preferably 80% or more, and particularly preferably 82% or more. The above spectral transmittance can be measured by a method described in Examples.

In the glass of the embodiment of the present invention, a ratio of a spectral transmittance at a wavelength of 600 nm to a spectral transmittance at a wavelength of 800 nm (spectral transmittance at wavelength of 600 nm/spectral transmittance at wavelength of 800 nm) is preferably 20 or more when conversion of a plate thickness is performed such that the IR half value is 630 nm. In this way, a glass having a high sharp cutting property in the near-infrared region is obtained. The above ratio of the spectral transmittances is more preferably 21 or more, further preferably 21.5 or more, and particularly preferably 22 or more. The above spectral transmittance can be measured by a method described in Examples.

The conversion of the plate thickness at which the IR half value of the glass of the embodiment of the present invention is 630 nm is performed using a formula (Tᵢ₂=Tᵢ₁^{(t2/t1)}). Tit indicates an internal transmittance (data excluding reflection loss of front and back surfaces) of a target glass at a wavelength of 630 nm, t1 indicates a plate thickness of the target glass, Tᵢ₂ indicates a transmittance of a converted value, and t2 indicates a plate thickness to be converted (plate thickness at which IR half value is 630 nm). The conversion from the transmittance to the internal transmittance was performed using the following formula, assuming that a reflection loss Ref of each of the front and back surfaces of the glass is 0.0454.

$$Internal transmittance = transmittance / \{ 100 \times {( 1 - Ref )}^{2} \}$$

In a case where the glass of the embodiment of the present invention is used for, for example, a color correction filter for a solid state image sensor, the glass is often used with a plate thickness of 0.4 mm or less. When conversion of a plate thickness is performed such that the IR half value is 630 nm, the plate thickness is preferably 0.4 mm or less, more preferably 0.3 mm or less, further preferably 0.25 mm or less, and still more preferably 0.23 mm or less. From the viewpoint of ensuring the strength of the glass, the plate thickness thereof is preferably 0.05 mm or more.

The glass of the embodiment of the present invention can be produced, for example, as follows.

First, raw materials are weighed and mixed so as to fall within the above composition range (mixing step). The raw material mixture is accommodated in a platinum crucible, and heated and melted at a temperature of 750° C. to 1,000° C. in an electric furnace (melting step). After being sufficiently stirred and refined, the raw material mixture is cast into a mold, cut and polished to form a flat plate having a predetermined plate thickness (molding step).

In the melting step of the above production method, the highest temperature of the glass during glass melting is preferably 1,000° C. or lower. When the highest temperature of the glass during the glass melting is higher than the above temperature, transmittance characteristics may deteriorate. The above temperature is more preferably 950° C. or lower, further preferably 930° C. or lower, and still more preferably 900° C. or lower.

When the temperature in the melting step is too low, problems such as occurrence of devitrification during melting and requirement of a long time for burn-through may occur, and thus the temperature is preferably 800° C. or higher, and more preferably 820° C. or higher.

The glass of the embodiment of the present invention is formed into a predetermined shape, and then an optical multilayer film may be provided on at least one surface of the glass. Examples of the optical multilayer film include an IR cut film (film reflecting near infrared rays), a UV/IR cut film (film reflecting ultraviolet rays and near infrared rays), a UV cut film (film reflecting ultraviolet rays), and an antireflection film. Such an optical thin film can be formed by a known method such as a vapor deposition method or a sputtering method.

An adhesion reinforcing film may be provided between the glass of the embodiment of the present invention and the above optical multilayer film. By providing the adhesion reinforcing film, the adhesion between the glass and the optical multilayer film is improved, and peeling of the film can be prevented. Examples of the adhesion reinforcing film include silicon oxide (SiO₂), titanium oxide (TiO₂), lanthanum titanate (La₂Ti₂O₇), aluminum oxide (Al₂O₃), a mixture of aluminum oxide and zirconium oxide (ZrO₂), magnesium fluoride (MgF₂), calcium fluoride (CaF₂), strontium fluoride (SrF₂), and fluorine silicone. A substance containing fluorine or oxygen has higher adhesion, and in particular, magnesium fluoride and/or titanium oxide has higher adhesion to a glass or a film, and thus are preferable as the adhesion reinforcing film. The adhesion reinforcing film may have a single layer or two or more layers. In the case of two or more layers, a plurality of substances may be combined.

### <Near-infrared Cut Filter>

A near-infrared cut filter of the embodiment of the present invention contains the glass of the embodiment of the present invention described above. Accordingly, a near-infrared cut filter that can maintain a high transmittance of light in the visible region (particularly blue light) while controlling a transmittance of light in the near-infrared region to be low can be obtained. The near-infrared cut filter of the embodiment of the present invention may have the following configuration in addition to the glass of the embodiment of the present invention.

The near-infrared cut filter of the embodiment of the present invention may include an absorption layer containing a near infrared ray absorbing material having a maximum absorption wavelength in the near-infrared region, on at least one main surface of the glass of the embodiment of the present invention. With such a configuration, a near-infrared cut filter that controls the transmittance of light in the near-infrared region to be lower can be obtained.

For the near-infrared cut filter of the embodiment of the present invention, it is preferable that a near infrared ray absorbing dye is added to a transparent resin and contained in an absorption layer, the transparent resin being made of one kind alone or two or more kinds of resins selected from an acrylic resin, an epoxy resin, an ene-thiol resin, a polycarbonate resin, a polyether resin, a polyarylate resin, a polysulfone resin, a polyethersulfone resin, a polyparaphenylene resin, a polyarylene ether phosphine oxide resin, a polyimide resin, a polyamide-imide resin, a polyolefin resin, a cyclic olefin resin, and a polyester resin.

As the near-infrared ray absorbing dye, it is preferable to use a near-infrared absorbing material including at least one selected from the group consisting of a squarylium dye, a phthalocyanine dye, a cyanine dye, and a diimmonium dye.

### <Optical Device>

The glass of the embodiment of the present invention can be applied to an optical device. The optical device is a device that utilizes light to record and transmit information. Examples of the optical device include an imaging device of a digital still camera and an optical sensor that detects light and converts the light into an electric signal. When the glass of the embodiment of the present invention is applied to the optical device, there is an advantage that the glass can contribute to reduction in size and height of the optical device since the glass has excellent absorption characteristics particularly in the near-infrared region.

When applied to the optical device, the glass of the embodiment of the present invention can be used in combination with an optical filter having light-absorbing characteristics different from those of the glass of the embodiment of the present invention. Examples of the light-absorbing characteristics of the optical filter include, for example, a characteristic of having an absorption ability in a wavelength range different from that of the glass of the embodiment of the present invention, or a characteristic of having a different absorption ability in the same near infrared wavelength range as the glass of the embodiment of the present invention. By applying the glass of the embodiment of the present invention in combination with the optical filter having different light-absorbing characteristics in the optical device, optical characteristics that are difficult to obtain with a single glass can be obtained. Examples of the optical filter include an infrared cut filter provided in the vicinity of an imaging element of an imaging device, a cover glass that covers an opening on a subject side of an optical device, and a lens provided inside an optical device. The glass and the optical filter of the embodiment of the present invention may be laminated and used.

As described above, the present description discloses the following.
[1] A fluorophosphate glass essentially containing each component of P, Al, K, Cu, F, and R, where R is one or more selected from Li, Na, Rb, and Cs,
   in which a content of Al³⁺ is 2% to 20% in terms of mass %, and
   an expected value of an ionic radius of an alkali metal component composed of K and R is 80 pm to less than 133 pm.
[2] The fluorophosphate glass according to [1],
   in which in terms of mass %, a total amount of ΣR⁺ and K⁺ is 14% to 42%, where R⁺ is one or more components selected from Li⁺, Na⁺, Rb⁺, and Cs⁺, and ΣR⁺ is a total amount of R⁺, and
   ΣR″²⁺ is 14.5% to 35%, where R″²⁺ is one or more components selected from Ba²⁺, Sr²⁺, Ca²⁺, and Mg²⁺, and ΣR″²⁺ is a total amount of R″²⁺.
[3] The fluorophosphate glass according to [1] or [2], in which a content of K⁺ is 1% to 40% in terms of mass %.
[4] The fluorophosphate glass according to any one of [1] to [3], in which the content of Al³⁺ is 3.5% to 20% in terms of mass %.
[5] The fluorophosphate glass according to any one of [1] to [4], containing, in terms of mass %,
   20% to 70% of P⁵⁺,
   3.5% to 20% of Al³⁺,
   1% to 40% of K⁺,
   0% to 30% of Li⁺,
   0% to 40% of Na⁺,
   0% to 20% of Rb⁺,
   0% to 20% of Cs⁺,
   0% to 20% of Mg²⁺,
   0% to 20% of Ca²⁺,
   0% to 30% of Sr²⁺,
   0% to 40% of Ba²⁺.
   1% to 20% of Cu²⁺,
   0% to 20% of Zn²⁺, and,
   containing, in terms of outer percentage, 3% to 60% of F⁻.
[6] The fluorophosphate glass according to any one of [1] to [5], in which (content of P⁵⁺)/ΣR′ is 3.0 to 7.7, where R′ is one or more components selected from Al³⁺, Mg²⁺, and Li⁺, and ΣR′ is a total amount of R′.
[7] The fluorophosphate glass according to any one of [1] to [4], in which when conversion of a plate thickness is performed such that a wavelength (IR half value) at which a transmittance in a near-infrared region is 50% is 630 nm, a plate thickness is 0.4 mm or less, a spectral transmittance at a wavelength of 1,200 nm is 22% or less, and a spectral transmittance at a wavelength of 600 nm is 60% or more.
[8] The fluorophosphate glass according to any one of [1] to [7], in which when conversion of a plate thickness is performed such that a wavelength (IR half value) at which a transmittance in a near-infrared region is 50% is 630 nm, a plate thickness is 0.4 mm or less, a spectral transmittance at a wavelength of 800 nm is 4% or less, and a spectral transmittance at a wavelength of 420 nm is 75% or more.
[9] The fluorophosphate glass according to any one of [1] to [8], in which when conversion of a plate thickness is performed such that a wavelength (IR half value) at which a transmittance in a near-infrared region is 50% is 630 nm, a plate thickness is 0.4 mm or less, a spectral transmittance ratio A/B is 20 or more where a spectral transmittance at a wavelength of 600 nm is A and a spectral transmittance at a wavelength of 800 nm is B.
[10] A near-infrared cut filter including the fluorophosphate glass according to any one of [1] to [9],
[11] An optical device including the fluorophosphate glass according to any one of [1] to [9].
[12] An optical device including:
   the fluorophosphate glass according to any one of [1] to [9]; and
   an optical filter having a light-absorbing characteristic different from that of the fluorophosphate glass.

### EXAMPLES

Hereinafter, the present invention is described with reference to Examples, but the present invention is not limited to these Examples.

Inventive examples and comparative examples of the fluorophosphate glass of the present invention are shown in Tables 1 to 4. Examples 1 to 7 and Examples 19 to 32 are inventive examples, and Examples 8 to 18 are comparative examples.

Example 10 shows results of producing and evaluating a glass corresponding to a glass composition of Example 9 described in Patent Literature 1.

### [Production of Glass]

For glasses of Examples 1 to 32, raw materials were weighed and mixed such that glass components after melting had compositions shown in Tables 1 to 4 (mass %, F⁻ is expressed in terms of outer percentage, and only alkali metal component is expressed with cation %). The mixture was charged into a platinum crucible having an internal volume of 1 L, and was heated at a melting temperature shown in each table in an electric furnace for 1 hour to 100 hours and melted. Thereafter, the mixture was refined, stirred, and cast into a rectangular mold having a length of 100 mm, a width of 65 mm, and a height of 20 mm that was preheated to 50° C. to 500° C., then held at 300° C. to 500° C. for 2 hours or more, and then slowly cooled at about 1° C./min to obtain a glass of a plate-shaped sample having a length of 40 mm, a width of 40 mm, and a plate thickness of 0.1 mm to 0.5 mm, both surfaces of which were optically polished.

Since F⁻ has high volatility, the content of F⁻ changes before and after melting. In the glasses of Examples 1 to 32, a value obtained by converting the content of F⁻ contained in the raw materials before melting is shown in the column of “converted value of raw material before melting F⁻”. In the glasses of Examples 1 to 7, 11 to 13, 19, 21 to 27, and 30, as the content of F⁻ contained in the glass after melting, a value analyzed by XRF (ZSX Primus II, manufactured by Rigaku Corporation) is shown in the column of “analyzed value after melting F⁻”.

In the glasses of Examples 1 to 7, 11 to 13, 19, 21 to 27, and 30, an average value of a content ratio of F⁻ before and after melting “analyzed value after melting F⁻”/“converted value of raw material before melting F⁻” was obtained, and a content of F⁻ contained after melting was estimated based on a content of the converted value of raw material before melting F⁻ of Examples 8 to 10, 14 to 18, 20, 28, 29, 31, and 32. The calculated value is shown in the column of “estimated value after melting F⁻”.

As the raw materials for each glass, the following raw materials were used.

In the case of P⁵⁺, H₃PO₄ was used.

In the case of Al³⁺, AlF₃ was used.

In the case of Li⁺, LiF and LiNO₃ were used.

In the case of Na⁺, NaF was used.

In the case of K⁺, KF was used.

In the case of Mg²⁺, MgO was used.

In the case of Ca²⁺, CaF₂ was used.

In the case of Sr²⁺, SrF₂ was used.

In the case of Ba²⁺, BaF₂ was used.

In the case of Cu²⁺, CuO was used.

In the case of Zn²⁺, ZnO was used.

In the case of F⁻, a fluoride raw material of the above components was used.

In addition to the components described in the inventive examples and comparative examples, the glass contains O²⁻ as an anion. A content of O²⁻ is not shown since it varies depending on the content of highly volatile F⁻, but all glasses in the inventive examples and comparative examples contain O²⁻.

The raw materials of the glass are not limited to the above, and known materials can be used.

### [Evaluation: Transmittance]

The transmittance was evaluated by the following procedure. For the produced optically polished glass, a transmittance of light in a wavelength of 300 nm to 1,200 nm was measured for each 1 nm using a spectrophotometer (V-570, manufactured by JASCO Corporation), and conversion of a plate thickness was performed such that the IR half value (wavelength at which transmittance in near-infrared region including reflection loss of front and rear surfaces was 50%) was 630 nm. The conversion was performed by first converting the obtained transmittance into an internal transmittance and then utilizing the following formula.

$${T}_{i 2} = {T}_{i 1}^{( t 2 / t 1 )}$$

$${T}_{i 1} : internal transmittance of actual sample ( before conversion )$$

$$t 1 : plate thickness of actual sample$$

$${T}_{i 2} : internal transmittance after conversion$$

$$t 2 : plate thickness to be converted$$

A spectral transmittance at a wavelength of 1,200 nm, a spectral transmittance B at a wavelength of 800 nm, a spectral transmittance A at a wavelength of 600 nm, and a spectral transmittance at a wavelength of 420 nm were calculated based on a transmittance including a reflection loss of front and back surfaces in the internal transmittance after conversion (Tᵢ₂), and a transmittance ratio A/B was calculated based on the transmittance A and the transmittance B. The conversion from the transmittance to the internal transmittance was performed using the following formula, assuming that a reflection loss Ref of each of the front and back surfaces of the glass was 0.0454. Internal transmittance=transmittance/{100×(1−Ref)²}

### [Evaluation: Weather Resistance]

The weather resistance was evaluated by the following procedure. A glass was allowed to stand in an atmosphere at a temperature of 85° C. and a humidity of 85% for 100 hours, and then visually observed under a high-luminance light source. A case where no foreign matter was deposited on a glass surface, no liquid was eluted, and no deterioration was observed was evaluated as “A”, a case where only a foreign matter was deposited on the glass surface or only a liquid was eluted was evaluated as “B”, and a case where both deposition of a foreign matter on the glass surface and elution of a liquid were observed was evaluated as “C”.

### [Evaluation: Solubility]

The solubility was evaluated by the following procedure. After being melted at 750° C. to 1,000° C., the glass was held and cooled under the conditions described above, and presence or absence of a devitrified product in the obtained glass was visually confirmed, and a case where a devitrified product was seen was evaluated as “C”, and a case where no devitrified product was seen was evaluated as “A”.

### (Evaluation: Young's Modulus)

The Young's modulus was evaluated by the following procedure. A glass was processed into a size of 30 mm×30 mm×10 mm, and a value measured by an ultrasonic pulse method (JIS R 1602: test method of elastic modulus of fine ceramics) was indicated in units of [GPa].

### [Evaluation: Average Coefficient of Thermal Expansion]

The average coefficient of thermal expansion was evaluated by the following procedure. For a glass processed into a rod shape, an average coefficient of thermal expansion at 30° C. to 300° C. was measured at a heating rate of 5° C./min by a thermal expansion method using a thermal analyzer (trade name: TMA8310, manufactured by Rigaku corporation).

Results are shown in Tables 1 to 4.

TABLE 1

| | | | Exam- | Exam- | Exam- | Exam- | Exam- | Exam- | Exam- | Exam- | Exam- |
|---|---|---|---|---|---|---|---|---|---|---|---|
| | | | ple 1 | ple 2 | ple 3 | ple 4 | ple 5 | ple 6 | ple 7 | ple 8 | ple 9 |
| Base glass | P⁵⁺ | mass % | 35.6 | 37.5 | 36.9 | 36.9 | 35.9 | 35.5 | 38.2 | 35.4 | 48.7 |
| | Al³⁺ | mass % | 6.6 | 7.0 | 7.5 | 7.5 | 7.3 | 7.2 | 9.5 | 6.5 | 5.0 |
| | Li⁺ | mass % | 0.0 | 0.0 | 0.0 | 0.0 | 0.0 | 0.0 | 1.6 | 4.4 | 0.0 |
| | Na⁺ | mass % | 3.6 | 11.4 | 7.5 | 7.5 | 3.4 | 1.7 | 5.1 | 0.0 | 8.8 |
| | K⁺ | mass % | 18.4 | 6.4 | 12.7 | 12.7 | 18.8 | 21.5 | 8.8 | 0.0 | 0.0 |
| | Rb⁺ | mass % | 0.0 | 0.0 | 0.0 | 0.0 | 0.0 | 0.0 | 0.0 | 0.0 | 0.0 |
| | Cs⁺ | mass % | 0.0 | 0.0 | 0.0 | 0.0 | 0.0 | 0.0 | 0.0 | 0.0 | 0.0 |
| | Mg²⁺ | mass % | 0.0 | 0.0 | 0.0 | 0.0 | 0.0 | 0.0 | 0.0 | 1.5 | 0.0 |
| | Ca²⁺ | mass % | 4.3 | 4.5 | 4.5 | 4.5 | 4.4 | 4.3 | 4.6 | 4.7 | 0.0 |
| | Sr²⁺ | mass % | 6.9 | 7.3 | 7.1 | 7.1 | 6.9 | 6.9 | 7.4 | 12.8 | 7.6 |
| | Ba²⁺ | mass % | 14.5 | 15.3 | 15.0 | 15.0 | 14.6 | 14.5 | 15.6 | 24.6 | 17.8 |
| | Cu²⁺ | mass % | 10.1 | 10.6 | 8.8 | 8.8 | 8.6 | 8.5 | 9.2 | 10.2 | 12.1 |
| | Zn²⁺ | mass % | 0.0 | 0.0 | 0.0 | 0.0 | 0.0 | 0.0 | 0.0 | 0.0 | 0.0 |
| | Total | mass % | 100.0 | 100.0 | 100.0 | 100.0 | 100.0 | 100.0 | 100.0 | 100.0 | 100.0 |
| Outer percentage | [Converted | mass % | 36.9 | 38.9 | 39.6 | 39.6 | 38.6 | 38.1 | 44.8 | 42.6 | 26.1 |
| | value of raw | | | | | | | | | | |
| | material before | | | | | | | | | | |
| | melting] F⁻ | | | | | | | | | | |
| | [Analyzed | mass % | 14.4 | 14.1 | 15.3 | 14.3 | 15.9 | 15.9 | 17.1 | No Data | No Data |
| | value after | | | | | | | | | | |
| | melting] F⁻ | | | | | | | | | | |
| | [Estimated | mass % | — | — | — | — | — | — | — | 15.3 | 9.4 |
| | value after | | | | | | | | | | |
| | melting] F⁻ | | | | | | | | | | |
| ΣR⁺ + K⁺ | | mass % | 22.0 | 17.8 | 20.1 | 20.1 | 22.3 | 23.2 | 15.5 | 4.4 | 8.8 |
| ΣR″²⁺ | | mass % | 25.7 | 27.1 | 26.6 | 26.6 | 25.9 | 25.6 | 27.6 | 43.5 | 25.4 |
| P⁵⁺/(Al³⁺ + Li⁺ + Mg²⁺) | | — | 5.4 | 5.4 | 4.9 | 4.9 | 4.9 | 4.9 | 3.4 | 2.9 | 9.7 |
| Expected value of ionic radius of alkali | | pm | 123.5 | 104.5 | 114.0 | 114.0 | 124.0 | 128.5 | 96.0 | 60.0 | 95.0 |
| metal component | | | | | | | | | | | |
| Base glass (alkali | Li⁺ | cation % | 0.0 | 0.0 | 0.0 | 0.0 | 0.0 | 0.0 | 8.2 | 23.8 | 0.0 |
| metal component) | Na⁺ | cation % | 6.3 | 19.0 | 12.7 | 12.7 | 6.0 | 3.0 | 8.2 | 0.0 | 15.0 |
| | K⁺ | cation % | 19.0 | 6.3 | 12.7 | 12.7 | 19.3 | 22.3 | 8.2 | 0.0 | 0.0 |
| | Rb⁺ | cation % | 0.0 | 0.0 | 0.0 | 0.0 | 0.0 | 0.0 | 0.0 | 0.0 | 0.0 |
| | Cs⁺ | cation % | 0.0 | 0.0 | 0.0 | 0.0 | 0.0 | 0.0 | 0.0 | 0.0 | 0.0 |
| Melting temperature | | ° C. | 950 | 950 | 950 | 900 | 950 | 950 | 950 | 950 | 950 |
| Solubility | | | A | A | A | A | A | A | A | A | A |
| Evaluation of weather resistance | | | A | A | A | A | A | A | A | A | C |
| Young's modulus | | GPa | 55.2 | 61.5 | 57.3 | 57.6 | 56.3 | 51.8 | 69.2 | 80.2 | 62.3 |
| Average coefficient of thermal | | ×10⁻⁷/° C. | 162.9 | 150.9 | 151.3 | 152.3 | 155.3 | 162.3 | 135.4 | 123.3 | 115.0 |
| expansion (30° C. to 300° C.) | | | | | | | | | | | |
| Plate thickness | | mm | 0.17 | 0.16 | 0.23 | 0.19 | 0.22 | 0.21 | 0.19 | 0.16 | 0.22 |
| Transmittance | Wavelength: | % | 19.6 | 21.0 | 18.2 | 17.5 | 17.6 | 22.1 | 21.4 | 24.0 | 8.3 |
| | 1,200 nm | | | | | | | | | | |
| | Wavelength: | % | 3.0 | 3.1 | 2.7 | 2.5 | 2.6 | 3.5 | 3.3 | 3.6 | 1.0 |
| | 800 nm | | | | | | | | | | |
| | Wavelength: | % | 5.9 | 6.0 | 5.4 | 5.2 | 5.5 | 6.6 | 6.2 | 6.4 | 3.1 |
| | 750 nm | | | | | | | | | | |
| | Wavelength: | % | 15.6 | 15.5 | 14.9 | 14.5 | 15.0 | 16.3 | 15.6 | 15.6 | 12.0 |
| | 700 nm | | | | | | | | | | |
| | Wavelength: | % | 67.3 | 67.5 | 67.8 | 68.1 | 67.7 | 67.1 | 67.7 | 67.8 | 69.1 |
| | 600 nm | | | | | | | | | | |
| | Wavelength: | % | 84.5 | 84.5 | 85.2 | 85.9 | 85.0 | 84.9 | 84.9 | 84.6 | 86.6 |
| | 550 nm | | | | | | | | | | |
| | Wavelength: | % | 79.7 | 79.6 | 81.2 | 84.9 | 81.0 | 82.8 | 80.7 | 80.3 | 85.9 |
| | 420 nm | | | | | | | | | | |
| | Wavelength of | — | 22.5 | 21.5 | 25.5 | 27.4 | 25.6 | 19.1 | 20.3 | 18.9 | 66.3 |
| | 600 nm/ | | | | | | | | | | |
| | wavelength | | | | | | | | | | |
| | of 800 nm | | | | | | | | | | |
| | IR half value | nm | 630 | 630 | 630 | 630 | 630 | 630 | 630 | 630 | 630 |

TABLE 2

| | | | Exam- | Exam- | Exam- | Exam- | Exam- | Exam- | Exam- | Exam- | Exam- |
|---|---|---|---|---|---|---|---|---|---|---|---|
| | | | ple 10 | ple 11 | ple 12 | ple 13 | ple 14 | ple 15 | ple 16 | ple 17 | ple 18 |
| Base glass | P⁵⁺ | mass % | 37.2 | 35.3 | 36.0 | 36.4 | 33.8 | 30.5 | 27.8 | 34.3 | 38.0 |
| | Al³⁺ | mass % | 2.3 | 6.5 | 4.7 | 4.0 | 4.4 | 4.0 | 3.6 | 0.0 | 1.8 |
| | Li⁺ | mass % | 0.0 | 0.0 | 0.0 | 0.0 | 0.0 | 0.0 | 0.0 | 0.0 | 2.1 |
| | Na⁺ | mass % | 12.8 | 0.0 | 0.0 | 0.0 | 0.0 | 0.0 | 0.0 | 0.0 | 0.0 |
| | K⁺ | mass % | 0.0 | 24.2 | 24.7 | 13.8 | 23.2 | 12.7 | 9.5 | 0.0 | 0.0 |
| | Rb⁺ | mass % | 0.0 | 0.0 | 0.0 | 0.0 | 0.0 | 18.1 | 0.0 | 0.0 | 0.0 |
| | Cs⁺ | mass % | 0.0 | 0.0 | 0.0 | 0.0 | 0.0 | 0.0 | 32.4 | 0.0 | 0.0 |
| | Mg²⁺ | mass % | 12.2 | 0.0 | 0.0 | 1.9 | 0.0 | 0.0 | 0.0 | 1.4 | 0.0 |
| | Ca²⁺ | mass % | 5.6 | 4.3 | 4.4 | 3.1 | 4.1 | 3.7 | 3.4 | 3.1 | 0.0 |
| | Sr²⁺ | mass % | 0.0 | 6.8 | 7.0 | 6.7 | 6.5 | 5.9 | 5.4 | 14.4 | 0.0 |
| | Ba²⁺ | mass % | 19.2 | 14.4 | 14.7 | 10.6 | 13.8 | 12.4 | 11.3 | 21.7 | 54.3 |
| | Cu²⁺ | mass % | 10.7 | 8.4 | 8.6 | 11.2 | 14.1 | 12.7 | 6.6 | 9.3 | 3.8 |
| | Zn²⁺ | mass % | 0.0 | 0.0 | 0.0 | 12.4 | 0.0 | 0.0 | 0.0 | 15.7 | 0.0 |
| | Total | mass % | 100.0 | 100.0 | 100.0 | 100.0 | 100.0 | 100.0 | 100.0 | 100.0 | 100.0 |
| Outer percentage | [Converted | mass % | 26.0 | 36.6 | 33.2 | 23.9 | 31.2 | 24.1 | 20.9 | 15.2 | 24.5 |
| | value of raw | | | | | | | | | | |
| | material before | | | | | | | | | | |
| | melting] F⁻ | | | | | | | | | | |
| | [Analyzed value | mass % | No Data | 14.9 | 11.7 | 7.5 | No Data | No Data | No Data | No Data | No Data |
| | after melting] F⁻ | | | | | | | | | | |
| | [Estimated | mass % | 9.4 | — | — | — | 11.2 | 8.7 | 7.5 | 5.5 | 8.8 |
| | value after | | | | | | | | | | |
| | melting] F⁻ | | | | | | | | | | |
| ΣR⁺ + K⁺ | | mass % | 12.8 | 24.2 | 24.7 | 13.8 | 23.2 | 30.8 | 41.9 | 0.0 | 2.1 |
| ΣR°²⁺ | | mass % | 37.0 | 25.5 | 26.0 | 22.2 | 24.4 | 22.0 | 20.0 | 40.7 | 54.3 |
| P⁵⁺/(Al³⁺ + Li⁺ + Mg²⁺) | | — | 2.6 | 5.4 | 7.6 | 6.2 | 7.6 | 7.6 | 7.6 | 24.1 | 9.8 |
| Expected value of ionic radius of | | pm | 95.0 | 133.0 | 133.0 | 133.0 | 133.0 | 138.9 | 151.0 | — | 60.0 |
| alkali metal component | | | | | | | | | | | |
| Base glass (alkali | Li⁺ | cation % | 0.0 | 0.0 | 0.0 | 0.0 | 0.0 | 0.0 | 0.0 | 0.0 | 14.5 |
| metal component) | Na⁺ | cation % | 20.0 | 0.0 | 0.0 | 0.0 | 0.0 | 0.0 | 0.0 | 0.0 | 0.0 |
| | K⁺ | cation % | 0.0 | 25.6 | 26.4 | 15.0 | 25.3 | 15.3 | 13.2 | 0.0 | 0.0 |
| | Rb⁺ | cation % | 0.0 | 0.0 | 0.0 | 0.0 | 0.0 | 10.0 | 0.0 | 0.0 | 0.0 |
| | Cs⁺ | cation % | 0.0 | 0.0 | 0.0 | 0.0 | 0.0 | 0.0 | 13.2 | 0.0 | 0.0 |
| Melting temperature | | ° C. | 900 | 950 | 950 | 950 | 900 | 900 | 950 | 950 | 950 |
| Solubility | | | A | A | A | A | A | A | A | C | C |
| Evaluation of weather resistance | | | A | B | C | B | B | B | C | No Data | No Data |
| Young's modulus | | GPa | 77.4 | 46.9 | 47.4 | 61.7 | 49.7 | 48.1 | 57.3 | No Data | No Data |
| Average coefficient of thermal | | ×10⁻⁷/° C. | 128.8 | 166.5 | 167.3 | 133.6 | 162.3 | 165.5 | No Data | No Data | No Data |
| expansion (30° C. to 300° C.) | | | | | | | | | | | |
| Plate thickness | | mm | 0.16 | 0.21 | 0.21 | 0.13 | 0.11 | 0.11 | 0.22 | No Data | No Data |
| Transmittance | Wavelength: | % | 24.3 | 16.7 | 16.2 | 21.6 | 18.5 | 18.2 | 15.4 | No Data | No Data |
| | 1,200 nm | | | | | | | | | | |
| | Wavelength: | % | 3.5 | 2.6 | 2.4 | 3.9 | 3.3 | 3.2 | 2.4 | No Data | No Data |
| | 800 nm | | | | | | | | | | |
| | Wavelength: | % | 6.2 | 5.6 | 5.2 | 7.0 | 6.4 | 6.3 | 5.4 | No Data | No Data |
| | 750 nm | | | | | | | | | | |
| | Wavelength: | % | 15.3 | 15.2 | 14.7 | 16.6 | 16.2 | 16.2 | 15.2 | No Data | No Data |
| | 700 nm | | | | | | | | | | |
| | Wavelength: | % | 68.1 | 67.4 | 67.8 | 67.1 | 67.0 | 66.9 | 67.3 | No Data | No Data |
| | 600 nm | | | | | | | | | | |
| | Wavelength: | % | 85.8 | 84.8 | 85.8 | 84.3 | 84.4 | 84.3 | 85.0 | No Data | No Data |
| | 550 nm | | | | | | | | | | |
| | Wavelength: | % | 85.2 | 80.9 | 85.3 | 80.0 | 81.5 | 80.9 | 81.6 | No Data | No Data |
| | 420 nm | | | | | | | | | | |
| | Wavelength of | — | 19.3 | 25.6 | 28.7 | 17.4 | 20.3 | 21.0 | 27. | No Data | No Data |
| | 600 nm/ | | | | | | | | | | |
| | wavelength | | | | | | | | | | |
| | of 800 nm | | | | | | | | | | |
| | IR half value | nm | 630 | 630 | 630 | 630 | 630 | 630 | 630 | No Data | No Data |

TABLE 3

| | | | Exam- | Exam- | Exam- | Exam- | Exam- | Exam- | Exam- | Exam- | Exam- |
|---|---|---|---|---|---|---|---|---|---|---|---|
| | | | ple 19 | ple 20 | ple 21 | ple 22 | ple 23 | ple 24 | ple 25 | ple 26 | ple 27 |
| Base glass | P⁵⁺ | mass % | 37.1 | 36.9 | 37.4 | 37.8 | 43.8 | 33.3 | 34.9 | 35.5 | 37.0 |
| | Al³⁺ | mass % | 7.5 | 7.5 | 6.5 | 6.9 | 7.0 | 6.8 | 5.8 | 4.6 | 4.7 |
| | Li⁺ | mass % | 0.0 | 0.0 | 0.0 | 0.0 | 3.0 | 0.0 | 0.0 | 0.0 | 0.0 |
| | Na⁺ | mass % | 7.5 | 7.5 | 9.2 | 9.8 | 9.3 | 6.7 | 7.1 | 7.2 | 7.5 |
| | K⁺ | mass % | 12.8 | 12.7 | 6.3 | 5.5 | 2.3 | 11.4 | 12.0 | 12.2 | 12.7 |
| | Rb⁺ | mass % | 0.0 | 0.0 | 0.0 | 0.0 | 0.0 | 0.0 | 0.0 | 0.0 | 0.0 |
| | Cs⁺ | mass % | 0.0 | 0.0 | 0.0 | 0.0 | 0.0 | 0.0 | 0.0 | 0.0 | 0.0 |
| | Mg²⁺ | mass % | 0.0 | 0.0 | 0.0 | 0.0 | 0.0 | 0.0 | 0.0 | 0.0 | 2.5 |
| | Ca²⁺ | mass % | 4.5 | 3.6 | 2.1 | 1.1 | 2.3 | 0.0 | 4.2 | 4.3 | 4.5 |
| | Sr²⁺ | mass % | 5.1 | 5.3 | 11.8 | 12.4 | 10.1 | 6.4 | 6.8 | 6.9 | 7.2 |
| | Ba²⁺ | mass % | 15.1 | 15.0 | 14.7 | 15.6 | 11.9 | 27.4 | 20.9 | 14.5 | 15.1 |
| | Cu²⁺ | mass % | 10.4 | 11.5 | 11.9 | 10.8 | 10.3 | 8.0 | 8.4 | 14.8 | 8.9 |
| | Zn²⁺ | mass % | 0.0 | 0.0 | 0.0 | 0.0 | 0.0 | 0.0 | 0.0 | 0.0 | 0.0 |
| | Total | mass % | 100.0 | 100.0 | 100.0 | 100.0 | 100.0 | 100.0 | 100.0 | 100.0 | 100.0 |
| Outer percentage | [Converted | mass % | 38.9 | 38.0 | 35.7 | 36.1 | 41.7 | 35.7 | 36.6 | 32.7 | 33.9 |
| | value of raw | | | | | | | | | | |
| | material before | | | | | | | | | | |
| | melting] F⁻ | | | | | | | | | | |
| | [Analyzed value | mass % | 14.6 | No Data | 10.2 | 10.2 | 12.4 | 13.5 | 14.6 | 12.4 | 12.1 |
| | after melting] F⁻ | | | | | | | | | | |
| | [Estimated | mass % | — | 13.7 | — | — | — | — | — | — | — |
| | value after | | | | | | | | | | |
| | melting] F⁻ | | | | | | | | | | |
| ΣR⁺ + K⁺ | | mass % | 20.2 | 20.1 | 15.5 | 15.3 | 14.6 | 18.2 | 19.1 | 19.4 | 20.2 |
| ΣP°²⁺ | | mass % | 24.7 | 24.0 | 28.6 | 29.2 | 24.3 | 33.8 | 31.9 | 25.6 | 29.2 |
| P⁵⁺/(Al³⁺ + Li⁺ + Mg²⁺) | | — | 4.9 | 4.9 | 5.7 | 5.5 | 4.4 | 4.9 | 6.0 | 7.6 | 5.1 |
| Expected value of ionic radius of | | pm | 114.0 | 114.0 | 105.9 | 104.5 | 80.5 | 114.0 | 114.0 | 114.0 | 114.0 |
| alkali metal component | | | | | | | | | | | |
| Base glass (alkali | Li⁺ | cation % | 0.0 | 0.0 | 0.0 | 0.0 | 14.5 | 0.0 | 0.0 | 0.0 | 0.0 |
| metal component) | Na⁺ | cation % | 12.7 | 12.7 | 16.1 | 17.0 | 13.5 | 12.7 | 12.7 | 12.6 | 12.7 |
| | K⁺ | cation % | 12.7 | 12.7 | 6.5 | 5.7 | 1.9 | 12.7 | 12.7 | 12.6 | 12.7 |
| | Rb⁺ | cation % | 0.0 | 0.0 | 0.0 | 0.0 | 0.0 | 0.0 | 0.0 | 0.0 | 0.0 |
| | Cs⁺ | cation % | 0.0 | 0.0 | 0.0 | 0.0 | 0.0 | 0.0 | 0.0 | 0.0 | 0.0 |
| Melting temperature | | ° C. | 870 | 870 | 870 | 870 | 870 | 870 | 870 | 900 | 870 |
| Solubility | | | A | A | A | A | A | A | A | A | A |
| Evaluation of weather resistance | | | A | A | A | A | A | A | A | A | A |
| Young's modulus | | GPa | 58.9 | 59.5 | 63.7 | 64.1 | 69.0 | 55.1 | 55.6 | 57.7 | 57.2 |
| Average coefficient of thermal | | ×10⁻⁷/° C. | 148.9 | 148.2 | 140.5 | 138.6 | 141.3 | 161.6 | 160.7 | 157.7 | 156.0 |
| expansion (30° C. to 300° C.) | | | | | | | | | | | |
| Plate thickness | | mm | 0.18 | 0.16 | 0.13 | 0.14 | 0.19 | 0.21 | 0.19 | 0.11 | 0.20 |
| Transmittance | Wavelength: | % | 17.0 | 17.0 | 19.2 | 19.0 | 19.9 | 17.5 | 21.3 | 20.8 | 18.7 |
| | 1,200 nm | | | | | | | | | | |
| | Wavelength: | % | 2.5 | 2.6 | 3.0 | 3.0 | 2.6 | 2.4 | 3.0 | 3.1 | 2.7 |
| | 800 nm | | | | | | | | | | |
| | Wavelength: | % | 5.3 | 5.3 | 5.9 | 5.9 | 5.2 | 5.0 | 5.8 | 5.9 | 5.4 |
| | 750 nm | | | | | | | | | | |
| | Wavelength: | % | 14.7 | 14.7 | 15.4 | 15.5 | 14.2 | 14.4 | 15.3 | 15.3 | 14.7 |
| | 700 nm | | | | | | | | | | |
| | Wavelength: | % | 68.0 | 68.0 | 67.7 | 67.5 | 68.6 | 68.0 | 67.7 | 67.5 | 68.1 |
| | 600 nm | | | | | | | | | | |
| | Wavelength: | % | 86.0 | 86.0 | 85.2 | 84.8 | 86.5 | 85.6 | 85.6 | 84.7 | 86.2 |
| | 550 nm | | | | | | | | | | |
| | Wavelength: | % | 86.6 | 86.1 | 84.1 | 84.3 | 87.4 | 85.8 | 86.4 | 80.8 | 86.7 |
| | 420 nm | | | | | | | | | | |
| | Wavelength of | — | 26.7 | 26.5 | 22.3 | 22.2 | 26.3 | 28.7 | 22.5 | 22.0 | 25.2 |
| | 600 nm/ | | | | | | | | | | |
| | wavelength | | | | | | | | | | |
| | of 800 nm | | | | | | | | | | |
| | IR half value | nm | 630 | 630 | 630 | 630 | 630 | 630 | 630 | 630 | 630 |

TABLE 4

| | | | Exam- | Exam- | Exam- | Exam- | Exam- |
|---|---|---|---|---|---|---|---|
| | | | ple 28 | ple 29 | ple 30 | ple 31 | ple 32 |
| Base glass | P⁵⁺ | mass % | 35.7 | 35.8 | 36.9 | 36.1 | 43.7 |
| | Al³⁺ | mass % | 5.9 | 5.9 | 6.1 | 7.3 | 8.9 |
| | Li⁺ | mass % | 0.0 | 0.0 | 0.0 | 0.0 | 1.4 |
| | Na⁺ | mass % | 7.2 | 7.2 | 7.4 | 7.3 | 15.1 |
| | K⁺ | mass % | 12.3 | 12.3 | 12.7 | 12.4 | 3.4 |
| | Rb⁺ | mass % | 0.0 | 0.0 | 0.0 | 0.0 | 0.0 |
| | Cs⁺ | mass % | 0.0 | 0.0 | 0.0 | 0.0 | 0.0 |
| | Mg²⁺ | mass % | 0.0 | 0.0 | 0.0 | 0.0 | 0.0 |
| | Ca²⁺ | mass % | 4.3 | 4.3 | 4.5 | 4.4 | 1.8 |
| | Sr²⁺ | mass % | 6.9 | 6.9 | 7.1 | 7.0 | 5.8 |
| | Ba²⁺ | mass % | 14.5 | 14.6 | 15.0 | 14.7 | 9.5 |
| | Cu²⁺ | mass % | 8.5 | 8.6 | 8.8 | 8.6 | 10.5 |
| | Zn²⁺ | mass % | 0.0 | 0.0 | 0.0 | 0.0 | 0.0 |
| | Y | mass % | 0.0 | 4.4 | 0.0 | 0.0 | 0.0 |
| | Si | mass % | 0.0 | 0.0 | 1.4 | 0.0 | 0.0 |
| | Nb | mass % | 4.6 | 0.0 | 0.0 | 0.0 | 0.0 |
| | W | mass % | 0.0 | 0.0 | 0.0 | 2.3 | 0.0 |
| | Total | mass % | 100.0 | 100.0 | 100.0 | 100.0 | 100.0 |
| Outer percentage | [Converted value of raw material before | mass % | 35.5 | 35.6 | 36.7 | 38.7 | 43.5 |
| | melting] F⁻ | | | | | | |
| | [Analyzed value after melting] F⁻ | mass % | No Data | No Data | 11.0 | No Data | No Data |
| | [Estimated value after melting] F⁻ | mass % | 12.8 | 12.8 | — | 13.9 | 15.7 |
| ΣR⁺ + K⁺ | | mass % | 19.5 | 19.5 | 20.1 | 19.7 | 19.9 |
| ΣR″²⁺ | | mass % | 25.8 | 25.8 | 26.6 | 26.0 | 17.0 |
| P⁵⁺/(Al³⁺ + Li⁺ + Mg²⁺) | | — | 6.0 | 6.0 | 6.0 | 4.9 | 4.3 |
| Expected value of ionic radius of alkali metal component | | pm | 114.0 | 114.0 | 114.0 | 114.0 | 91.0 |
| Base glass (alkali metal | Li⁺ | cation % | 0.0 | 0.0 | 0.0 | 0.0 | 6.7 |
| component) | Na⁺ | cation % | 12.7 | 12.7 | 12.7 | 12.6 | 21.7 |
| | K⁺ | cation % | 12.7 | 12.7 | 12.7 | 12.6 | 2.9 |
| | Rb⁺ | cation % | 0.0 | 0.0 | 0.0 | 0.0 | 0.0 |
| | Cs⁺ | cation % | 0.0 | 0.0 | 0.0 | 0.0 | 0.0 |
| Melting temperature | | ° C. | 870 | 870 | 870 | 850 | 950 |
| Solubility | | | A | A | A | A | A |
| Evaluation of weather resistance | | | A | A | A | A | A |
| Young's modulus | | GPa | 56.8 | 57.2 | 57.8 | 58.2 | 67.7 |
| Average coefficient of thermal expansion (30° C. to 300° C.) | | ×10⁻⁷/° C. | 153.6 | 155.7 | 153.1 | 151.9 | 148.2 |
| Plate thickness | | mm | 0.21 | 0.19 | 0.19 | 0.20 | 0.19 |
| Transmittance | Wavelength: 1,200 nm | % | 17.2 | 21.4 | 20.4 | 18.0 | 19.2 |
| | Wavelength: 800 nm | % | 2.4 | 3.2 | 3.0 | 2.7 | 2.6 |
| | Wavelength: 750 nm | % | 5.1 | 6.0 | 5.9 | 5.4 | 5.3 |
| | Wavelength: 700 nm | % | 14.5 | 15.4 | 15.4 | 14.8 | 14.5 |
| | Wavelength: 600 nm | % | 68.0 | 67.8 | 67.7 | 68.0 | 68.2 |
| | Wavelength: 550 nm | % | 85.9 | 86.1 | 85.7 | 85.9 | 85.6 |
| | Wavelength: 420 nm | % | 83.8 | 87.3 | 86.9 | 84.1 | 82.2 |
| | Wavelength of 600 nm/ | — | 27.9 | 21.5 | 22.4 | 25.7 | 16.2 |
| | wavelength of 800 nm | | | | | | |
| | IR half value | nm | 630 | 630 | 630 | 630 | 630 |

Regarding Example 5 (inventive example) and Example 10 (comparative example), the transmittance obtained by performing conversion of a plate thickness such that the IR half value is 630 nm is illustrated in the FIGURE.

In each of the examples of the present invention, a glass having high absorption ability and sharp cutting property in the near-infrared region, no devitrification (good solubility), and good weather resistance was obtained.

In contrast, the glasses of Examples 8 to 18 as comparative examples were as follows.

In Example 8, since an expected value of an ionic radius of an alkali metal component was less than 80 pm, a glass having good weather resistance but low absorption ability and sharp cutting property in the near-infrared region was obtained.

In Example 9, since only one alkali metal component was contained and (content of P⁵⁺)/ΣR′ (R′ is one or more components selected from Al³⁺, Mg²⁺, and Li⁺, and ΣR′ is a total amount of R′) was larger than 7.5, a glass having high absorption ability and sharp cutting property in the near-infrared region but low weather resistance was obtained.

In Example 10, since the (content of P⁵⁺)/ΣR′ (R′ is one or more components selected from Al³⁺, Mg²⁺, and Li⁺, and ΣR′ is a total amount of R′) was less than 3.0, a glass having good weather resistance but low absorption ability and sharp cutting property in the near-infrared region was obtained.

In Examples 11 to 14, since only one alkali metal component was contained and an expected value of an ionic radius of an alkali metal component was 133 pm or more, a glass having high absorption ability and sharp cutting property in the near-infrared region but low weather resistance was obtained.

In Examples 15 and 16, since two types of alkali metal components were contained but the expected value of the ionic radius of the alkali metal component was 133 pm or more, a glass having high absorption ability and sharp cutting property in the near-infrared region but low weather resistance was obtained.

In Example 17, since ΣR⁺ was less than 14%, devitrification occurred, resulting in a glass with low solubility.

Based on Example 17, it was suggested that the solubility was improved by setting the content of ER within a predetermined range.

In Example 18, since ΣR⁺ was less than 14% and ΣR″⁺ was more than 40%, devitrification occurred, resulting in a glass with low solubility.

Based on Example 18, it was suggested that the solubility was improved by setting the content of ΣR⁺ and the content of ΣR″⁺ within predetermined ranges.

The present application claims priority based on Japanese Patent Application No. 2023-109751 filed on Jul. 4, 2023, and the entire contents thereof are incorporated herein by reference in the present application.

What is claimed is:

1. A fluorophosphate glass essentially comprising each component of P, Al, K, Cu, F, and R, where R is one or more selected from Li, Na, Rb, and Cs,
wherein a content of Al³: is 2% to 20% in terms of mass %, and
an expected value of an ionic radius of an alkali metal component composed of K and R is 80 pm to less than 133 pm.

2. The fluorophosphate glass according to claim 1,
wherein in terms of mass %, a total amount of ΣR⁺ and K⁺ is 14% to 42%, where R⁺ is one or more components selected from Li⁺, Na⁺, Rb⁺, and Cs⁺, and ΣR⁺ is a total amount of R⁺, and
ΣR″²⁺ is 14.5% to 35%, where R″²⁺ is one or more components selected from Ba²⁺, Sr²⁺, Ca²⁺, and Mg²⁺, and ΣR″²⁺ is a total amount of R″²⁺.

3. The fluorophosphate glass according to claim 1,
wherein a content of K⁺ is 1% to 40% in terms of mass %.

4. The fluorophosphate glass according to claim 1,
wherein the content of Al³⁺ is 3.5% to 20% in terms of mass %.

5. The fluorophosphate glass according to claim 1, comprising, in terms of mass %,
20% to 70% of P⁵⁺,
3.5% to 20% of Al³⁺,
1% to 40% of K⁺,
0% to 30% of Li⁺,
0% to 40% of Na⁺,
0% to 20% of Rb⁺,
0% to 20% of Cs⁺,
0% to 20% of Mg²⁺,
0% to 20% of Ca²⁺,
0% to 30% of Sr²⁺,
0% to 40% of Ba²⁺,
1% to 20% of Cu²⁺,
0% to 20% of Zn²⁺, and,
comprising, in terms of outer percentage, 3% to 60% of F⁻.

6. The fluorophosphate glass according to claim 1,
wherein (content of P⁵⁺)/ΣR′ is 3.0 to 7.7, where R′ is one or more components selected from Al³⁺, Mg²⁺, and Li⁺, and ΣR′ is a total amount of R′.

7. The fluorophosphate glass according to claim 1,
wherein when conversion of a plate thickness is performed such that a wavelength (IR half value) at which a transmittance in a near-infrared region is 50% is 630 nm, a plate thickness is 0.4 mm or less, a spectral transmittance at a wavelength of 1,200 nm is 22% or less, and a spectral transmittance at a wavelength of 600 nm is 60% or more.

8. The fluorophosphate glass according to claim 1,
wherein when conversion of a plate thickness is performed such that a wavelength (IR half value) at which a transmittance in a near-infrared region is 50% is 630 nm, a plate thickness is 0.4 mm or less, a spectral transmittance at a wavelength of 800 nm is 4% or less, and a spectral transmittance at a wavelength of 420 nm is 75% or more.

9. The fluorophosphate glass according to claim 1,
wherein when conversion of a plate thickness is performed such that a wavelength (IR half value) at which a transmittance in a near-infrared region is 50% is 630 nm, a plate thickness is 0.4 mm or less, a spectral transmittance ratio A/B is 20 or more where a spectral transmittance at a wavelength of 600 nm is A and a spectral transmittance at a wavelength of 800 nm is B.

10. A near-infrared cut filter comprising the fluorophosphate glass according to claim 1.

11. An optical device comprising the fluorophosphate glass according to claim 1.

12. An optical device comprising:
the fluorophosphate glass according to claim 1; and
an optical filter having a light-absorbing characteristic different from that of the fluorophosphate glass.
